(19) United States
(12) Patent Application Publication
(10) Pub. No.: US 2026/0358474 A1
(43) Pub. Date: Nov. 12, 2026

(54) OBJECT DETECTION USING RADIO SENSOR DATA

(71) Applicant: Alarm.com Incorporated, Tysons, VA (US)

(72) Inventors: Donald Gerard Madden, Barcelona (ES); Glenn Tournier, Vienna, VA (US); John Daniel Riordan, Barcelona (ES)

(21) Appl. No.: 19/668,232

(22) Filed: May 5, 2026

Related U.S. Application Data
(60) Provisional application No. 63/800,664, filed on May 6, 2025.

(51) Int. Cl. G01S 7/41; G01S 7/00; G01S 13/08; G01S 13/87; G01S 13/88

(52) U.S. Cl. CPC G01S 7/415; G01S 7/003; G01S 13/08; G01S 13/87; G01S 13/886

(57) ABSTRACT

Methods, systems, and apparatus, including computer programs encoded on computer storage media, for detecting an object using radio sensor data. One of the methods includes maintaining, by a first system for a first property, radio sensor data that was captured by a radio receiver from radio waves reflected off of objects within a threshold distance of the first property, receiving, by the first system and from a second system for a second property, a message that includes a representation of an object and indicates whether the object is likely an object of interest, determining whether the radio sensor data encodes another representation of the object that satisfies a similarity criterion for the representation of the object, and performing one or more actions using a result of the determination whether the radio sensor data encodes another representation of the object that satisfies the similarity criterion for the representation of the object.

### CROSS-REFERENCE TO RELATED APPLICATION

This application claims the benefit of U.S. Provisional Application No. 63/800,664, filed on May 6, 2025, the contents of which are incorporated by reference herein.

### BACKGROUND

Systems can detect objects. For instance, a system can use a sensor to detect an object and determine whether the object is an object of interest. In some instances, the system can use radio frequency waves to detect an object.

### SUMMARY

In general, one aspect of the subject matter described in this specification can be embodied in methods that include the actions of maintaining, by a first system for a first property, radio sensor data that was captured by a radio receiver from radio waves reflected off of objects within a threshold distance of the first property, receiving, by the first system and from a second system for a second property, a message that includes a representation of an object and indicates whether the object is likely an object of interest, determining whether the radio sensor data encodes another representation of the object that satisfies a similarity criterion for the representation of the object included in the message, and performing one or more actions using a result of the determination whether the radio sensor data encodes another representation of the object that satisfies the similarity criterion for the representation of the object included in the message.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination.

In some implementations, the method can include prior to receiving the message, determining that the other representation of the object likely represents an object of interest for the first property; and in response to determining that the other representation of the object likely represents an object of interest for the first property, determining to wait for the message from the second system for the second property. This can occur instead of the system triggering an action for the object. The system can make this determination given a predicted location of the object.

In some implementations, receiving the message can include receiving the message that includes the representation of an object and indicates that the object is likely an object of interest for the second property. Performing the one or more actions can include: determining whether the object is an object of interest for the first property; and in response to determining that the object is an object of interest for the first property and receiving the message that indicates that the object is likely an object of interest for the second property, triggering an alert.

In some implementations, receiving the message can include receiving the message that includes the representation of an object and indicates that the object is likely an object of interest for the second property. Performing the one or more actions can include: determining whether the object is an object of interest for the first property; and in response to determining that the object is not an object of interest for the first property and receiving the message that indicates that the object is likely an object of interest for the second property, transmitting, to the second system for the second property, a second message that indicates that the object is not an object of interest for the first property.

In some implementations, receiving the message can include receiving the message that includes the representation of an object and indicates that the object is likely an object of interest. Performing the one or more actions can include triggering an alert in response to determining that the radio sensor data encodes another representation of the object that satisfies the similarity criterion for the representation of the object that is likely an object of interest.

In some implementations, performing the one or more actions can include: determining a predicted location for the object; determining whether the predicted location for the object is at the second property; and in response to determining that the predicted location for the object is not likely at the second property, triggering an alert.

In some implementations, performing the one or more actions can include: determining a predicted location for the object; determining whether the predicted location for the object is at the second property; and in response to determining that the predicted location for the object is likely at the second property, determining to skip triggering an alert.

In some implementations, receiving the message can include receiving the message that identifies first event data for a first event that includes the object. Performing the one or more actions can include, in response to determining that the radio sensor data encodes another representation of the object that satisfies the similarity criterion for the representation of the object that is likely an object of interest: retrieving, from the radio sensor data and using the other representation of the object, second event data for a second event that includes the object; generating an event series model for the object using the first event data for the first event that includes the object and the second event data for the second event that includes the object; and performing an action using the event series model for the object.

In some implementations, the method can include receiving at least some of the radio sensor data from the second property. This can include receiving the first event data, the second event data, or both, from the second system for the second property.

In some implementations, the method can include selecting, from a plurality of actions and using the event series model for the object, the action.

In some implementations, receiving the message can include receiving the message that indicates that the object is likely a person, an animal, or a vehicle.

In some implementations, receiving the message can include receiving the message that includes the representation of an object and indicates that the object is not likely an object of interest. Performing the one or more actions can include discarding the radio sensor data in response to determining that the radio sensor data encodes another representation of the object that satisfies the similarity criterion for the representation of the object that is not likely an object of interest.

In some implementations, performing the one or more actions can include: determining a predicted location for the object; determining whether the predicted location for the object is at the second property; and in response to determining that the predicted location for the object is at the second property, discarding the radio sensor data.

In some implementations, receiving the message can include receiving the message that indicates that the object is not likely a person, an animal, or a vehicle.

In some implementations, include receiving the message can include receiving the message that indicates that the object is a known object for the second property.

In some implementations, the representation of the object can include a radio frequency representation of the object.

In some implementations, the first system can be physically installed at the first property.

In some implementations, the first system can be a cloud computing system for the first property.

The subject matter described in this specification can be implemented in various implementations and may result in one or more of the following advantages. In some implementations, the systems and methods described in this specification can reduce potential privacy issues, e.g., by processing radio sensor data that was captured by a radio receiver from radio waves reflected off of objects within a threshold distance of a property. This can include processing by determining whether the radio sensor data encodes another representation of an object that satisfies a similarity criterion, e.g., instead of processing camera data or only camera data. In some implementations, the system and methods described in this specification can more accurately track objects of interest, e.g., by determining whether the radio sensor data encodes another representation of the object that satisfies a similarity criterion for the representation of the object included in the message received from a neighbor’s property. For instance, by sharing data with a neighboring property, e.g., at least some of which is based on radio sensor data, the system can detect objects of interest that move between the property and the neighboring property that would not be detected otherwise, e.g., given a lack of sensors for at least a portion of that physical space between the properties.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A-B depict an example environment of a property monitoring system using radio sensor data to detect objects at a property.

FIG. 2 is a flow diagram of a process for using radio sensor data to determine whether to perform an action.

FIG. 3 is a diagram illustrating an example of a property monitoring system.

Like reference numbers and designations in the various drawings indicate like elements.

### DETAILED DESCRIPTION

Sometimes, a system might need to detect an object of interest at a property. This can occur when the system detects a potential intruder or receives input from a person at a property, such as a property owner. For instance, a property owner may want to find their lost dog or watch a potentially malicious actor breaking into the property. The system can use sensors at the property to detect, track, or both, the object of interest. However, the system might not have sensors that cover the entirety of the property.

To enhance the accuracy of the detection, a system can communicate with other systems for object detection. In some implementations, the system can detect an object of interest using data captured by sensors at the property and data shared by a neighbor's system. In some implementations, the system can deploy or otherwise use a radio sensor device instead of a security camera or other visual sensor devices, e.g., to reduce privacy invasion.

To detect an object of interest at a property, a system can use both radio sensor data of an object maintained by itself and a message regarding the object received from a neighbor’s system to determine whether the object is the object of interest. The object can be one of a person, an animal, or a vehicle. The radio sensor data can represent radio waves captured by a radio receiver of the system. The radio waves can be generated in the form of Wi-Fi, Ultra-wideband (UWB), LoRa, cellular, or any other appropriate type of radio waves. The radio waves can be reflected off the object, e.g., within a threshold distance of the property owner’s property.

The system can determine whether the radio sensor data encodes a first representation of the object that satisfies a similarity criterion for a second representation of the object in the message received from the neighbor’s system. If so, the system can determine, using other data from the message, an action to perform. For instance, when the message indicates that the object is a known object for the neighbor’s property, the system can determine to skip generating an alert. When the message indicates that the object is not a known object for the neighbor’s property and the system does not associate the object with a known object for the property, the system can determine that the object is likely an object of interest and trigger an alert.

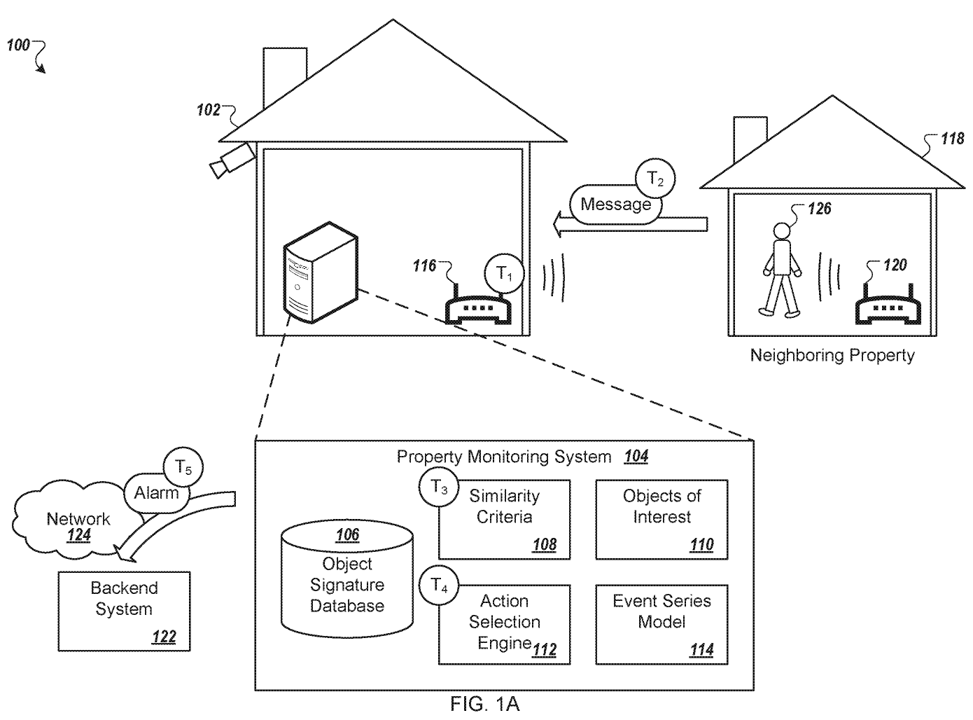

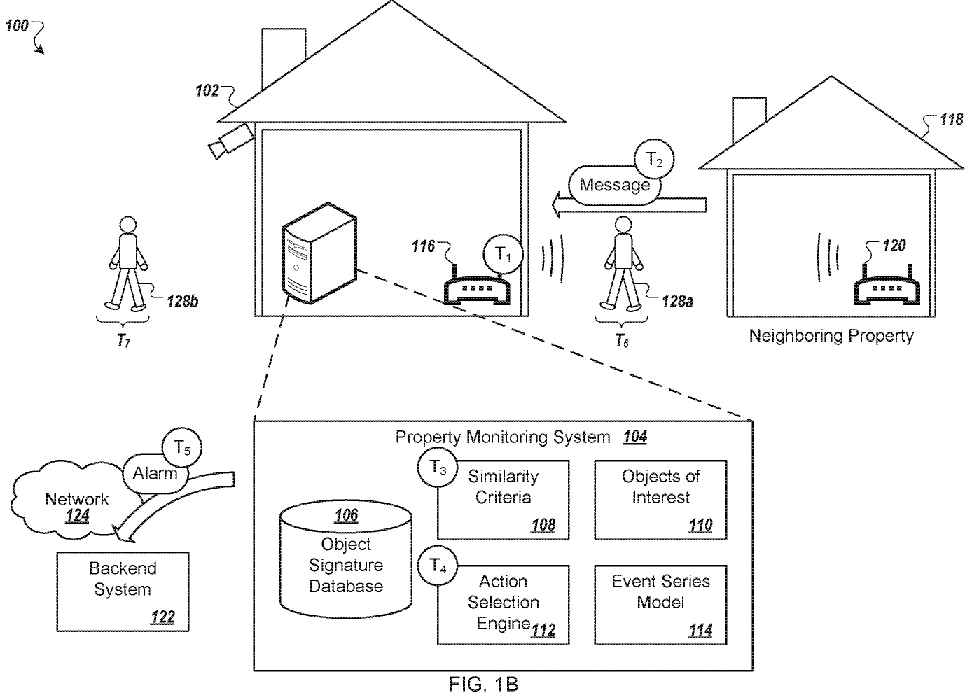

FIGS. 1A-B depict an example environment 100 of a property monitoring system 104 using radio sensor data to detect objects at a property 102. The property monitoring system 104 can detect an object, determines whether the object is an object of interest using the shared data from a neighbor property, and triggers alerts based on the determination.

The environment 100 includes a radio device 116. The radio device 116 can be any appropriate type of device that transmits, receives, or both, radio sensor data. For instance, the radio device 116 can be a router, an access point, bridge receiver, or another appropriate device, that is physically located at the property 102. The radio device 116 can be physically located inside or outside a building on the property 102.

For instance, the radio device 116 can broadcast or otherwise transmit radio waves. This can occur when a wireless router broadcasts radio waves that enable other devices to wirelessly connect to the radio device 116.

The transmitted radio waves can reflect off one or more objects that are each within a first threshold distance of the radio device 116, the property 102, or both. For example, the first threshold distance can be defined by the type of radio waves transmitted by the radio device 116, e.g., since different wireless protocols have different transmission distances. Some examples of objects can include people, animals, vehicles, or furniture at the property, such as a couch. In some examples, the first threshold distance can indicate that the object is inside a building at the property 102, or on a yard around the building.

In some examples, the radio transmitter that generated the radio waves that reflected off the object can be within a second threshold distance of the property 102, e.g., given the type of radio waves transmitted by the radio transmitter. The first threshold distance and the second threshold distance can be the same distance or different distances.

During time period T₁, the reflected radio waves, e.g., that encode radio sensor data, can be detected by a radio receiver. For instance, the radio device 116 can include a radio receiver that detects the reflected radio waves. The reflect radio waves can be radio waves that were originally transmitted by the radio device 116 or another radio device, e.g., another radio device 120 at a neighboring property 118. In this example, the other radio device 120 and the radio device 116 can each be a Wi-Fi router.

Since the radio waves reflected off an object, the radio sensor data encodes a representation of the object. For instance, the radio sensor data can indicate a model or other properties of the object, such as the shape of the object, the distance of the object from the radio receiver, or both. In FIG. 1A, the radio sensor data can encode properties of a person 126 at the neighboring property 118. This radio sensor data can be captured by the radio device 116 at the property.

In some implementations, the property monitoring system 104 maintains an object signature database 106, e.g., for one or more known objects at the property 102. A known object can be an object that is authorized to be at the property 102. In some instances, a known object can be an object that is unauthorized to be at the property 102, e.g., a stray cat that sometimes comes onto the property 102 but should be deterred from entering the property, for which an alert should be generated, or both. The object signature database 106 can include object representations or other appropriate data for objects. For instance, the object signature database 106 can maintain data that identifies properties of objects, such as a model, an object shape, or both. The property monitoring system 104 can use the object signature database 106 to determine a type of an object represented by the radio sensor data, a particular object represented by the radio sensor data, or both. For instance, the property monitoring system 104 can compare at least a subset of the radio sensor data with data from the object signature database 106 to determine a predicted object type, such as car, truck, person, dog, deer, bear, or snake.

The property monitoring system 104 can maintain some of the object signature data as specific to particular entities. This can include the property monitoring system 104 maintaining a signature for a particular person, a particular vehicle, or a particular pet. In some examples, the particular person can be a property owner or manager.

The property monitoring system 104 can receive the radio sensor data from the radio device 116. The property monitoring system 104 can maintain, e.g., store, the received radio sensor data in memory, e.g., in a database.

The property monitoring system 104 receives, during time period T₂, a message from a neighboring system at the neighboring property 118. For examples, the property monitoring system 104 can receive the message from the neighboring radio device 120, e.g., router, at the neighboring property 118.

The message can encode data about an object detected by the neighboring system. For instance, the message can encode a representation of a second object, an indication whether the second object is likely an object of interest for the neighboring property, or both. The indication whether the second object is likely an object of interest can be any appropriate type of data, e.g., a binary value that indicates “yes, object of interest” or “no, not an object of interest”. The object of interest can be an object that is neither an authorized occupant of the property nor another object known object for the property, e.g., a pet or a vehicle.

In some implementations, a detected object can be any of at least three types: a known object, such as a resident of a property for which an alert should not be triggered; an object of interest for which an alert should be triggered or another action performed or both; or neither of the above, e.g., a detected tree branch moving in the wind. An object of interest can be any appropriate type of object, such as a person, an animal, or a vehicle. In some instances, the message can encode data that indicates whether the second object is a known object, e.g., separate from just indicating that the second object is not an object of interest.

The property monitoring system 104 can receive the message at any appropriate time. For example, the neighboring system can transmit a message in response to detecting the second object, detecting movement of the second object, according to a schedule, at another appropriate time, or any combination of these. Given the example shown in FIG. 1A, the transmission can occur in response to the neighboring system detecting the person 126 in the neighboring property 118.

The property monitoring system 104 can receive the message using any appropriate protocol. In some examples, the property monitoring system 104 can use the radio device 116 to receive the message, e.g., when the radio device 116 is a router. In these examples, the radio device 116 is coupled to the property monitoring system 104 using a wired connection, a wireless connection, or both. The property monitoring system 104 can receive the message using a wired connection or a wireless connection. The property monitoring system 104 can receive the message through a wireless communication network, e.g., Wi-Fi, UWB, Bluetooth, Zigbee, cellular networks, LoRa, or any other appropriate network.

In some implementations, the property monitoring system 104 can use any appropriate data format to communicate with, e.g., receive the message from, the neighboring system. For instance, the property monitoring system 104 can receive the message that is encoded in channel state information, metadata, any other appropriate message or data format, or any combination of these. By receiving the message in one of these formats, the message can be less likely to have privacy concerns compared to other types of messages transmitted using other protocols, e.g., messages that can contain more data. The transmission of messages with the neighboring system can be limited, e.g., by the property monitoring system 104, to using secured protocols. In some instances, when the property monitoring system 104 receives the message from the radio device 116, or another device that uses wireless communications, the device can switch networks to receive the message.

For instance, the device can normally connect to the radio device 116 at the property 102. In these implementations, the device can be physically located at the property 102, owned or otherwise controlled by a person associated with the property 102, or both. When the device determines that a message might be available from the neighboring property 118, e.g., according to a schedule, the device can switch networks to connect to the neighboring radio device 120. The device can communicate, e.g., transmit, receive, or both, one or more messages with the neighboring radio device 120. The device can receive the message from the neighboring system. The device can then connect to the radio device 116, disconnecting from the neighboring radio device 120. The device can then use the radio device 116 to transmit the message to the property monitoring system 104.

In some implementations, the device that switches networks can initially connect to the neighboring radio device 120 and then connect to the radio device 116 at the property 102 for transmission of the message. In these implementations, the device can be physically located at the neighboring property 118, owned or otherwise controlled by a person associated with the neighboring property 118, or both. For example, the device can normally connect to the neighboring radio device 120 at the neighboring property 118. When the device determines that a message might be available from the property 102, e.g., according to a schedule, the device can switch networks to connect to the radio device 116. The device can communicate, e.g., transmit, receive, or both, one or more messages with the radio device 116. The device can receive the message from the property monitoring system 104. The device can then connect to the neighboring radio device 120, disconnecting from the radio device 116. The device can then use the neighboring radio device 120 to transmit the message to the system for the neighboring property 118.

The message includes a representation of a second object. The representation can be any appropriate type of representation, such as a signature for the second object, a multi-dimensional model of the second object, one or more properties of the object, feature data specific to the object, or any combination of these.

During time period T₃, the property monitoring system 104 compares the captured radio sensor data, e.g., captured by the radio device 116, with some of the data from the message. For instance, the property monitoring system 104 can determine whether the captured radio sensor data satisfies at least one of one or more similarity criteria 108 with respect to the data from the message, e.g., the representation of the second object. This comparison operation can be part of the property monitoring system 104 determining whether the object represented by the sensor data captured by the radio device 116 at the property 102 is the same object as the second object for which a representation is encoded in the message. This second object can be detected by the neighboring radio device 120. For example, the property monitoring system 104 uses the two sets of data to determine whether both likely represent the same object, e.g., the person 126.

When the property monitoring system 104 determines that the captured radio sensor data does not satisfy any of the similarity criteria with respect to data from the message, the property monitoring system 104 can determine whether to perform an action using the radio sensor data and without using data from the message. For instance, the property monitoring system 104 can use a predicted location of the object, a predicted object type, a predicted object activity, or any combination of these, to determine an action to perform.

When the property monitoring system 104 determined that the captured radio sensor data satisfies at least one of the similarity criteria 108, the property monitoring system 104 can use at least some data from the message to determine an action to perform. For instance, during time period T₄, an action selection engine 112 can use the indication whether the second object is likely an object of interest for the neighboring property to select an action to perform.

Objects of interest can include either objects for which an alert should be triggered or objects for which an alert should not be triggered. The latter can include known objects, e.g., an authorized person who is at the neighboring property 118. Some examples describe a specific action being performed, such as triggering an alert, but can apply to other appropriate examples. In these implementations, there would be a particular action performed when the object is an object of interest, and a different action or no action would be performed if the object is not an object of interest, e.g., is a known object.

For instance, the property monitoring system 104, a system at the neighboring property, or both, can maintain data that indicates objects of interest 110. The objects of interest 110 can be part of the object signature database 106, a separate database, maintained on another appropriate memory, or any combination of these. In some examples, objects of interest can be people, animals, vehicles, or any combination of these. In some instances, objects of interest can include a subset of animals, e.g., deer and dogs but not squirrels.

The action selection engine 112 can use the object of interest data from the message to determine the action to perform. For instance, when the message indicates that the object is a known object for which an alert should likely not be triggered, the action selection engine 112 can determine to skip triggering an alert or performing another action that would be performed for an object of interest. When the message indicates that the object is object of interest, the action selection engine 112 can determine to trigger an alert or perform the other action. The action selection engine 112 can use the radio sensor data, the representation of the object that was included in the message, other appropriate data, or any combination of these, to select a corresponding action to perform.

The action selection engine 112 can use data from the object signature database 106 when determining an action to perform. In these examples, when the action selection engine 112 determines that the object is either a known object for the property 102 or a known object for the neighboring property 118, the action selection engine 112 can determine to skip performing an action. For instance, when the action selection engine 112 determines that the object is an object of interest for the neighboring property 118, the action selection engine 112 can determine to skip performing an action for the object. This can occur when the action selection engine 112 determines that the object is a known object for the property 102, e.g., using data from the object signature database 106 that identifies known objects for the property 102.

When the action selection engine 112 determines that the object is not a known object for the neighboring property 118 and is not a known object for the property 102, the action selection engine 112 can select an action to perform. The action can be any appropriate action, such as triggering an alert, emitting a sound to deter the object such as a person or an animal, or both. Upon determining to trigger an alert, the property monitoring system 104 can, during time period T₅, send an alarm signal to a backend system 122 or another system or device.

The action selection engine 112 can use a predicted location of the object when selecting an action to perform. For instance, when the person 126 is likely a neighbor who is located inside a building at the neighboring property 118, the action selection engine 112 can determine to skip performing any action. When the person 126 is likely a neighbor who is on the property 102, e.g., next to a building on the property 102, the action selection engine 112 might determine to perform an action. This might occur even though the neighbor is removing litter from the property, retrieving an item such as a ball that ended up on the property, or both.

The action selection engine 112 can use any appropriate process to predict the location of the object. For instance, the action selection engine 112 can use the direction of the reflected radio waves, a time parameter for the reflected radio waves, data from another sensor, or any combination of these, to determine the predicted location of the object. The time parameter can indicate a time from reflection, a time from transmission, a reception time, or any combination of these.

FIG. 1B depicts an example of the environment 100 that uses an event series model 114. An event series model 114 can be a model that indicates a series of events for an object. The series of events can indicate data for any appropriate types of events, such as actions performed by the object, movement of the object across time, or both. Some example actions can include knocking on a door, digging, waving, or opening a bag.

In FIG. 1B, a person 128a-b moves from a location between the property 102 and the neighboring property 118 to a location on the opposite side of the property 102. For instance, the person 128a-b can be walking between buildings on the two properties during a first time period T₆ and then, during a later time period T₇, walking on the opposite side of the building.

During the time period T₆, which can coincide at least in part with time period T₁, the radio device 116 can capture radio waves reflected from the person 128a while the person 128a is between the two properties. The property monitoring system 104 can communicate with the neighboring system as described above to determine whether to perform an action and, if so, what action to perform.

As the person 128 moves around the property 102, the property monitoring system 104 can capture additional sensor data that represents the person, receive additional sensor data from the second system for the neighboring property 118, or both. Although the examples below describe additional sensor data captured by the property monitoring system 104, similar examples can apply for data received from the second system for the neighboring property 118.

For example, when the person 128 moves within a field of view of a camera, the camera can capture image data that depicts the person. The camera can be physically located at the property 102 or the neighboring property 118. In some examples, the additional sensor data can be from multiple sensors, e.g., physically located at the property 102, the neighboring property 118, or any combination of both. The property monitoring system 104 can receive the image data from the camera. The property monitoring system 104 can analyze the image data and determine that the object represented by the image data, e.g., the person, is likely the same object that is represented by the radio sensor data that was encoded in the captured radio waves.

In response to this determination, the property monitoring system 104 can add data to an event series model 114 for the object. When an object is first detected, the property monitoring system 104 can determine whether to generate an event series model for the object, or begin generating an event series model for the object, e.g., without a separate determination. For example, when the property monitoring system 104 detects an object, the property monitoring system 104 can determine whether the object is likely an object of interest. If so, the property monitoring system 104 can determine to generate the event series model 114 for the object, e.g., using the action selection engine 112 with at least one of the selected actions being generation of the event series model.

As the property monitoring system 104 receives additional sensor data, the property monitoring system 104 can determine whether the additional sensor data satisfies one or more model addition criteria. The additional sensor data can be captured by a sensor at the property 102 or another property, such as radio sensor data from the neighboring radio device 120 at the neighboring property 118. The property monitoring system 104 can determine whether the sensor data represents additional data about the object or another object. If the sensor data represents additional data about another object, or does not represent data about any objects, e.g., any objects of interest, the property monitoring system 104 can determine to skip adding at least a subset of the sensor data to the event series model 114.

If the sensor data represents additional data about the object being tracked using the event series model 114, the property monitoring system 104 can determine whether to add at least a subset of the additional data, or data generated based on the additional data, to the event series model for the object. The property monitoring system 104 can use one or more model criteria when making this determination. For instance, the property monitoring system 104 can determine whether the additional data encodes any actions performed by the object that can be used to determine an action to perform, movement that satisfies a movement threshold, another appropriate criterion, or any combination of these. As a result, the property monitoring system 104 can reduce computational resource usage, e.g., memory usage, by only adding additional data to the event series model 114 that satisfies at least one of, or optionally all of, the one or more model criteria.

By adding additional data generated using data captured by other types of sensors, the property monitoring system 104 can generate an event series model 114 that is more robust than a model generated using radio sensor data alone. For instance, the addition of image data can enable the encoding of color and other properties of the object. The addition of radar data can enable the encoding of more accurate distance, velocity, or both, data about the object.

During the time period T₇, the radio device 116 can capture additional data about the person 128b, e.g., the object. For instance, the property monitoring system 104 can use a signature for the object to track the object while the object moves. The property monitoring system 104 can use a combination of types of sensor data to generate the signature for the object. For example, the property monitoring system 104 can detect the object using image data and, at least partially concurrently, using radio sensor data. The property monitoring system can build one or more signatures for the object, e.g., a visual signature, a radio signature, or both. The property monitoring system 104 can associate related signatures that are for the same object with each other, e.g., using an identifier, entry, or both, in a database. The property monitoring system 104 can use at least one of the signatures, e.g., the radio signature, to track the object using radio sensor data.

In this example, the person 128b is no longer at a location at which the neighboring radio device 120 can detect the person 128b. As a result, the property monitoring system 104 can use radio sensor data captured by the radio device 116 to update the event series model, e.g., without data from the neighboring radio device 120. By generating an event series model 114 using radio sensor data captured by the radio device 116, e.g., a Wi-Fi router, the property monitoring system 104 can build a more robust event series model 114 than would otherwise be available, e.g., given a lack of a different type of sensor on the other side of the property while radio waves move throughout at least a portion of that other side. The property monitoring system 104 can continue to track the object using, e.g., only, the radio sensor data until another sensor, e.g., a camera, detects the object. The property monitoring system 104 can use a signature for the other sensor’s type to determine that the other sensor detected the object being tracked using radio sensor data.

Over time, as the object, e.g., person 128, moves throughout a neighborhood, the property monitoring system 104 can share data with other properties about the movement of the object. This can include sharing at least a portion of the event series model 114 with a neighboring property, receiving sensor data from a neighboring property such as radio sensor data, or both. By sharing data about the object, the property monitoring system 104 or another system can more accurately track movement of the object through the neighborhood, e.g., the system can use the data such as the event series model to triangulate movement of the object. This can enable a system to access more accurate data about a potential intruder who, for instance, enters a different property while wearing a mask but was not wearing a mask when the passed by the property 102. In some examples, this can enable a system to determine movement of a pet that has wandered off of its owner’s yard.

In some implementations, by sharing radio sensor data, a system can reduce potential privacy concerns, e.g., reduce a likelihood that identifiable data is unnecessarily shared between properties. For instance, when systems for two or more properties are configured to not share image data, the systems might be configured to share less specific radio sensor data.

In some implementations, multiple systems can share data about a planned event. For instance, if the neighboring system receives data indicating that an event will occur at a specific date and time, e.g., for a holiday, the property monitoring system 104 can receive a message from the neighboring system that identifies the specific date and time. When the property monitoring system 104 determines that a current time period satisfies the specific date and time, e.g., the holiday event has likely started, the property monitoring system 104 can use data about the event, e.g., that was include in the message, to determine whether to perform an action, what action to perform, or both. For instance, when the property monitoring system 104 received the message from a system for the neighboring property 118, the property monitoring system 104 can determine to skip analysis of radio sensor data encoding objects between the two properties, e.g., at locations similar to the person 128a, while analyzing objects at other locations, e.g., at locations similar to the person 128b.

In some implementations, the action selection engine 112 can use data from other sensors in addition to radio sensor data when selecting an action to perform. For instance, the action selection engine 112 can use data from a camera, a motion sensor, a microphone, or any combination of these, to select the action.

The action can be any appropriate type of action, e.g., for a property monitoring system. In some instances, the selected action can be to perform no action. In these instances, the property monitoring system 104 can discard the radio sensor data used to make such a determination; determine to stop processing the radio sensor data with respect to the object, e.g., but process that radio sensor data with respect to another object represented by that radio sensor data; or both.

The object signature database 106 can maintain any appropriate type of signatures. For instance, the object signature database 106 might maintain only radio sensor data signatures, e.g., generated using radio sensor data for a radio device. The object signature database can maintain video signatures, e.g., generated using image data from one or more cameras. The object signature database 106 can associate the different types of signatures with each other that are for the same object, e.g., a specific person, a specific animal or a specific vehicle; the same type of object, e.g., a vehicle, person, or animal; or any combination of these.

A training system can train an engine that runs on the property monitoring system 104, the radio device, or any combination of both, that generates signatures. The training process can use a combination of different types of sensor data, e.g., image data and radio sensor data. The training process can enable the engine to detect object types, specific objects, or both.

For instance, when the training system is implemented on the property monitoring system 104, the training system can learn what a radio signature of a dog that lives at the property 102 looks like during the day. During the night, when the range of a camera at the property 102 is reduced, the property monitoring system 104 can use radio sensor data to, for example, detect the dog, boost a confidence of video analytics that are barely detecting the dog now, e.g., given the low light conditions, or any combination of both.

In some examples, the training system can tune the engine to more accurately detect a particular object, an object type, or both. For instance, the property monitoring system 104, when implementing the training system, can track a person visually with a camera as the person walk through the backyard of the property 102. The property monitoring system 104 can capture radio sensor data that also represents the movement of the person as they walk through the backyard. The property monitoring system 104 can use the two different data types during a training process of the engine to enable the engine to more accurately track the person, any person, or both. This can cause the engine to better detect types of objects, specific objects, or both, given attributes of the property 102, e.g., the trees and other attributes of the property 102 such as locations of furniture, plants, or landscaping.

The property monitoring system 104 is an example of a system implemented as computer programs on one or more computers in one or more locations, in which the systems, components, and techniques described in this specification are implemented. The network 124, such as a local area network (“LAN”), wide area network (“WAN”), the Internet, or a combination thereof, connects the property monitoring system 104, the backend system 122, and optionally one or more neighboring systems. The property monitoring system 104 can use a single computer or multiple computers operating in conjunction with one another, including, for example, a set of remote computers deployed as a cloud computing service.

The property monitoring system 104 can include several different functional components, including the action selection engine 112. This component can include one or more data processing apparatuses, can be implemented in code, or a combination of both. For instance, the component can include one or more data processors and instructions that cause the one or more data processors to perform the operations discussed in this specification.

The various functional components of the property monitoring system 104 can be installed on one or more computers as separate functional components or as different modules of a same functional component. For example, the components the property monitoring system 104 can be implemented as computer programs installed on one or more computers in one or more locations that are coupled to each through a network. In cloud-based systems for example, these components can be implemented by individual computing nodes of a distributed computing system.

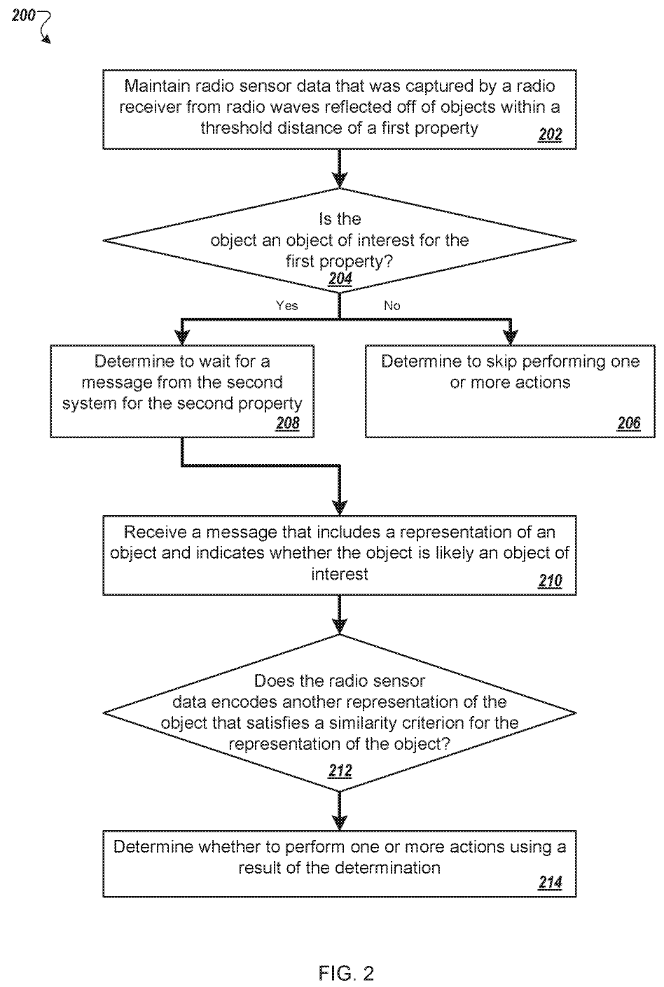

FIG. 2 is a flow diagram of a process 200 for using radio sensor data to determine whether to perform an action. For example, the process 200 can be used by the property monitoring system 104 from the environment 100.

A property monitoring system maintains radio sensor data that was captured by a radio receiver from radio waves reflected off of objects within a threshold distance of a first property (202). For instance, the property monitoring system received radio sensor data from the radio receiver. The radio receiver can be the same device that emitted the radio waves, e.g., can also be a radio transmitter. In some examples, the radio receiver can be a different device than the radio transmitter that emitted the radio waves, e.g., when a radio transmitter at a neighboring property emitted the radio waves. In some instances, the radio receiver can capture a combination of radio waves emitted by the radio receiver as a transmitter and another radio transmitter.

The property monitoring system determines whether the object is an object of interest for the first property (204). For instance, the property monitoring system can access a database that maintains data for objects of interest, an object signature database that maintains signatures of one or more known objects for the first property, or both. The property monitoring system can use at least a subset of data from an accessed database when making this determination.

The property monitoring system determines to skip performing one or more actions (206). For example, in response to determining that the object is not an object of interest, that the object is a known object, or both, the property monitoring system can determine to skip performing one or more actions. This can include a determination to currently skip performing an action for the object. As the property monitoring system processes additional data for the object, e.g., performs one or more additional operations from the process 200 such as operations 202 and 204, the property monitoring system can reassess the determination whether to skip performing actions for the object. For instance, although the property monitoring system might initially determine to skip performing an action for a neighbor’s pet, e.g., dog, the property monitoring system might later determine to perform an action, e.g., if the dog begins to dig a hole in the property.

The property monitoring system determines to wait for a message from the second system for the second property (208). For instance, in response to determining that the object is an object of interest, the property monitoring system can determine to wait to receive the message from the second system, e.g., for a neighboring property. By waiting, the property monitoring system can reduce false alerts that might otherwise be triggered, e.g., by known objects for the second system. This can occur when a neighbor passes between buildings on adjacent properties, such as when clearing their yard.

The property monitoring system receives a message that includes a representation of an object and indicates whether the object is likely an object of interest (210). The indication can be an indication whether the object is likely an object of interest for the second system. This can occur when different systems have different sets of objects of interest, e.g., when a deer is an object of interest for one system but not the other. The representation of the object can be any appropriate representation of an object.

The property monitoring system determines whether the radio sensor data encodes another representation of the object that satisfies a similarity criterion for the representation of the object (212). For instance, the property monitoring system can generate the other representation of the object using the radio sensor data. The property monitoring system can compare the other representation of an object with the representation of an object that was included in the message. If the two satisfy the similarity criterion, e.g., are sufficiently similar allowing for some margin of error given differences in detected data, the property monitoring system can determine that the two objects are likely the same object. If the two representations do not satisfy the similarity criterion, the property monitoring system can determine that the two objects are not likely the same object.

The property monitoring system determines whether to perform one or more actions using a result of the determination (214). The property monitoring system can use a result of the determination whether the similarity criterion is satisfied, the indication whether the object is likely an object of interest, e.g., for the second property, an event series model for the object, a location of the object, or any combination of these, when making this determination.

In some instances, the property monitoring system can select an action to perform from multiple different actions. The property monitoring system can use a result of the determination whether the similarity criterion is satisfied, the indication whether the object is likely an object of interest, e.g., for the second property, an event series model for the object, a location of the object, or any combination of these, to select the action. This can include the property monitoring system determining to select an action related to an alarm event, e.g., triggering an alarm, even though the message indicates that the object is not likely an object of interest. This can occur when the property monitoring system determines that an event series model, a location of the object, or both, indicate that an alarm event might be occurring.

When the property monitoring system determines that the object is not likely an object of interest, the property monitoring system can select, as an action, transmission of a message to the second system that indicates that the object is not likely an object of interest. This can occur so that, when the property monitoring system does not trigger an alarm event, the second system is less likely to trigger an alarm event, e.g., a false alarm. For instance, both systems can share data that reduces a likelihood of a false alarm. This can include the second system sharing data with the property monitoring system indicating when a known object for the second system is detected. The property monitoring system can share data with the second system that indicates when a known object for the property monitoring system is detected.

The order of operations in the process 200 described above is illustrative only, and using the radio sensor data to determine whether to perform the action can be performed in different orders. For example, the process 200 can include operation 204 after operation 212. In some instances, the process 200 can include operation 204 after operation 208.

In some implementations, the process 200 can include additional operations, fewer operations, or some of the operations can be divided into multiple operations. For example, the process 200 can include operations 202, 210, 212, and 214, optionally with operation 204. In some implementations, the process 200 can include operations 202 through 206. In implementations that include operation 208, the process 200 need not include operation 206.

The radio sensor data can be any appropriate type of radio sensor data. For instance, the radio sensor data can be captured from a radio wave, e.g., Wi-Fi, UWB, Bluetooth, Zigbee, LoRa, cellular, or any other appropriate radio wave.

The radio sensor data can be extracted from, or otherwise measured by, any appropriate portion of a radio wave. For instance, the radio sensor data can be measured by channel interference, channel state information, channel impulse response, channel frequency response data, RSRP, RSSI, or any other appropriate form.

Although some of the examples described in this specification refer to two systems sharing data, e.g., radio sensor data, some implementations can include more systems. For instance, three or five systems, each of a corresponding property in a neighborhood, can communicate with each other when appropriately configured.

For situations in which the systems discussed here collect personal information about people, or may make use of personal information, the people may be provided with an opportunity to control whether programs or features collect personal information (e.g., information about a person’s activities, a person’s preferences, or a person’s current location), or to control whether and/or how the system operates. In addition, certain data may be anonymized in one or more ways before it is stored or used, so that personally identifiable information is removed. For example, a person’s identity may be anonymized so that no personally identifiable information can be determined for the person. Thus, the person may have control over how information is collected about them and used.

In this specification, the term “database” can broadly to refer to any collection of data: the data does not need to be structured in any particular way, or structured at all, and it can be stored on storage devices in one or more locations. A database can be implemented on any appropriate type of memory.

In this specification the term “engine” can broadly to refer to a software-based system, subsystem, or process that is programmed to perform one or more specific functions. Generally, an engine will be implemented as one or more software modules or components, installed on one or more computers in one or more locations. In some instances, one or more computers will be dedicated to a particular engine. In some instances, multiple engines can be installed and running on the same computer or computers.

Operations, e.g., performed during any of the time periods T₁ to T₅, can occur substantially concurrently in that the operations need not be exactly concurrent but can overlap at least in part. For instance, a first operation can begin and sometime after that a second operation can begin while the first operation is still occurring. Execution of the two operations, whether by the same system or different systems, can be substantially concurrently. In some examples, two operations can execute substantially concurrently when they have the same start time, same end time, or both.

In this specification, the term likely can mean that there is a likelihood that something might occur and that the likelihood satisfies a likelihood threshold. For instance, when determining that an object is likely depicted in an image, a system would determine a likelihood that the object is depicted in the image. The system would then determine whether the likelihood satisfies, e.g., is greater than or equal to, a likelihood threshold by comparing the two values. If so, the system determines that the object is likely depicted in the image. If not, the system determines that the object is not likely depicted in the image.

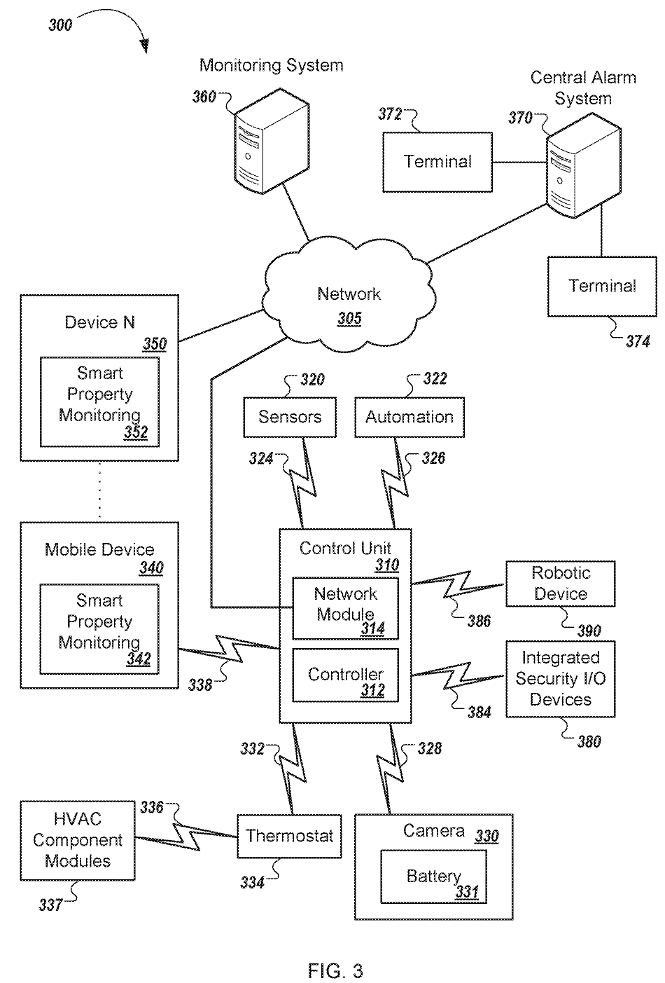

FIG. 3 is a diagram illustrating an example of an environment 300, e.g., for monitoring a property. The property can be any appropriate type of property, such as a home, a business, or a combination of both. The environment 300 includes a network 305, a control unit 310, one or more devices 340 and 350, a monitoring system 360, a central alarm system 370, or a combination of two or more of these. In some examples, the network 305 facilitates communications between two or more of the control unit 310, the one or more devices 340 and 350, the monitoring system 360, and the central alarm system 370.

The network 305 is configured to enable exchange of electronic communications between devices connected to the network 305. For example, the network 305 can be configured to enable exchange of electronic communications between the control unit 310, the one or more devices 340 and 350, the monitoring system 360, and the central alarm system 370. The network 305 can include, for example, one or more of the Internet, Wide Area Networks (“WANs”), Local Area Networks (“LANs”), analog or digital wired and wireless telephone networks (e.g., a public switched telephone network (“PSTN”), Integrated Services Digital Network (“ISDN”), a cellular network, and Digital Subscriber Line (“DSL”)), radio, television, cable, satellite, any other delivery or tunneling mechanism for carrying data, or a combination of these. The network 305 can include multiple networks or subnetworks, each of which can include, for example, a wired or wireless data pathway. The network 305 can include a circuit-switched network, a packet-switched data network, or any other network able to carry electronic communications (e.g., data or voice communications). For example, the network 305 can include networks based on the Internet protocol (“IP”), asynchronous transfer mode (“ATM”), the PSTN, packet-switched networks based on IP, X.25, or Frame Relay, or other comparable technologies and can support voice using, for example, voice over IP (“VoIP”), or other comparable protocols used for voice communications. The network 305 can include one or more networks that include wireless data channels and wireless voice channels. The network 305 can be a broadband network.

The control unit 310 includes a controller 312 and a network module 314. The controller 312 is configured to control a control unit monitoring system, e.g., a control unit system or a local monitoring system that is at a property, that includes the control unit 310. In some examples, the controller 312 can include one or more processors or other control circuitry configured to execute instructions of a program that controls operation of a control unit system. In these examples, the controller 312 can be configured to receive input from sensors, or other devices included in the control unit system and control operations of devices at the property, e.g., speakers, displays, lights, doors, other appropriate devices, or a combination of these. For example, the controller 312 can be configured to control operation of the network module 314 included in the control unit 310.

The network module 314 is a communication device configured to exchange communications over the network 305. The network module 314 can be a wireless communication module configured to exchange wireless, wired, or a combination of both, communications over the network 305. For example, the network module 314 can be a wireless communication device configured to exchange communications over a wireless data channel and a wireless voice channel. In some examples, the network module 314 can transmit alarm data over a wireless data channel and establish a two-way voice communication session over a wireless voice channel. The wireless communication device can include one or more of a LTE module, a GSM module, a radio modem, a cellular transmission module, or any type of module configured to exchange communications in any appropriate type of wireless or wired format.

The network module 314 can be a wired communication module configured to exchange communications over the network 305 using a wired connection. For instance, the network module 314 can be a modem, a network interface card, or another type of network interface device. The network module 314 can be an Ethernet network card configured to enable the control unit 310 to communicate over a local area network, the Internet, or a combination of both. The network module 314 can be a voice band modem configured to enable the alarm panel to communicate over the telephone lines of Plain Old Telephone Systems (“POTS”).

The control unit system that includes the control unit 310 can include one or more sensors 320. For example, the environment 300 can include multiple sensors 320. The sensors 320 can include a lock sensor, a contact sensor, a motion sensor, a camera (e.g., a camera 330), a flow meter, any other type of sensor included in a control unit system, or a combination of two or more of these. The sensors 320 can include an environmental sensor, such as a temperature sensor, a water sensor, a rain sensor, a wind sensor, a light sensor, a smoke detector, a carbon monoxide detector, or an air quality sensor, to name a few additional examples. The sensors 320 can include a health monitoring sensor, such as a prescription bottle sensor that monitors taking of prescriptions, a blood pressure sensor, a blood sugar sensor, or a bed mat configured to sense presence of liquid (e.g., bodily fluids) on the bed mat. In some examples, the health monitoring sensor can be a wearable sensor that attaches to a person, e.g., a user, at the property. The health monitoring sensor can collect various health data, including pulse, heartrate, respiration rate, sugar or glucose level, bodily temperature, motion data, or a combination of these. The sensors 320 can include a radio-frequency identification (“RFID”) sensor that identifies a particular article that includes a pre-assigned RFID tag.

The control unit 310 can communicate with a module 322 and a camera 330 to perform monitoring. The module 322 is connected to one or more devices that enable property automation, e.g., home or business automation. For instance, the module 322 can connect to, and be configured to control operation of, one or more lighting systems. The module 322 can connect to, and be configured to control operation of, one or more electronic locks, e.g., control Z-Wave locks using wireless communications in the Z-Wave protocol. In some examples, the module 322 can connect to, and be configured to control operation of, one or more appliances. The module 322 can include multiple sub-modules that are each specific to a type of device being controlled in an automated manner. The module 322 can control the one or more devices using commands received from the control unit 310. For instance, the module 322 can receive a command from the control unit 310, which command was sent using data captured by the camera 330 that depicts an area. In response, the module 322 can cause a lighting system to illuminate an area to provide better lighting in the area, and a higher likelihood that the camera 330 can capture a subsequent image of the area that depicts more accurate data of the area.

The camera 330 can be an image camera or other type of optical sensing device configured to capture one or more images. For instance, the camera 330 can be configured to capture images of an area within a property monitored by the control unit 310. The camera 330 can be configured to capture single, static images of the area; video of the area, e.g., a sequence of images; or a combination of both. The sequence of images can be a sequence of frames, e.g., when the video is compressed using a video codec. The image captured by the camera can be any appropriate type of image, e.g., a frame. The camera 330 can be controlled using commands received from the control unit 310 or another device in the property monitoring system, e.g., a device 350.

The camera 330 can be triggered using any appropriate techniques, can capture images continuously, or a combination of both. For instance, a Passive Infra-Red (“PIR”) motion sensor can be built into the camera 330 and used to trigger the camera 330 to capture one or more images when motion is detected. The camera 330 can include a microwave motion sensor built into the camera which is used to trigger the camera 330 to capture one or more images when motion is detected. The camera 330 can have a “normally open” or “normally closed” digital input that can trigger capture of one or more images when external sensors detect motion or other events. The external sensors can include another sensor from the sensors 320, PIR, or door or window sensors, to name a few examples. In some implementations, the camera 330 receives a command to capture an image, e.g., when external devices detect motion or another potential alarm event or in response to a request from a device. The camera 330 can receive the command from the controller 312, directly from one of the sensors 320, or a combination of both.

In some examples, the camera 330 triggers integrated or external illuminators to improve image quality when the scene is dark. Some examples of illuminators can include Infra-Red, Z-wave controlled “white” lights, lights controlled by the module 322, or a combination of these. An integrated or separate light sensor can be used to determine if illumination is desired and can result in increased image quality.

The camera 330 can be programmed with any combination of time schedule, day schedule, system “arming state”, other variables, or a combination of these, to determine whether images should be captured when one or more triggers occur. The camera 330 can enter a low-power mode when not capturing images. In this case, the camera 330 can wake periodically to check for inbound messages from the controller 312 or another device. The camera 330 can be powered by internal, replaceable batteries, e.g., if located remotely from the control unit 310. The camera 330 can employ a small solar cell to recharge the battery when light is available. The camera 330 can be powered by a wired power supply, e.g., the controller’s 312 power supply if the camera 330 is co-located with the controller 312.

In some implementations, the camera 330 communicates directly with the monitoring system 360 over the network 305. The monitoring system 360 can be part of a local monitoring system at the property or a remote monitoring system at a geographic location remote from the property. In these implementations, image data captured by the camera 330 need not pass through the control unit 310, e.g., when the monitoring system is a remote monitoring system. The camera 330 can receive commands related to operation from the monitoring system 360, provide images to the monitoring system 360, or a combination of both.

The environment 300 can include one or more thermostats 334, e.g., to perform dynamic environmental control at the property. The thermostat 334 is configured to monitor temperature of the property, energy consumption of a heating, ventilation, and air conditioning (“HVAC”) system associated with the thermostat 334, or both. In some examples, the thermostat 334 is configured to provide control of environmental (e.g., temperature) settings. In some implementations, the thermostat 334 can additionally or alternatively receive data relating to activity at a property; environmental data at a property, e.g., at various locations indoors or outdoors or both at the property; or a combination of both. The thermostat 334 can measure or estimate energy consumption of the HVAC system associated with the thermostat. The thermostat 334 can estimate energy consumption, for example, using data that indicates usage of one or more components of the HVAC system associated with the thermostat 334. The thermostat 334 can communicate various data, e.g., temperature, energy, or both, with the control unit 310. In some examples, the thermostat 334 can control the environment, e.g., temperature, settings in response to commands received from the control unit 310.

In some implementations, the thermostat 334 is a dynamically programmable thermostat and can be integrated with the control unit 310. For example, the dynamically programmable thermostat 334 can include the control unit 310, e.g., as an internal component to the dynamically programmable thermostat 334. In some examples, the control unit 310 can be a gateway device that communicates with the dynamically programmable thermostat 334. In some implementations, the thermostat 334 is controlled via one or more modules 322.

The environment 300 can include the HVAC system or otherwise be connected to the HVAC system. For instance, the environment 300 can include one or more HVAC modules 337. The HVAC modules 337 can be connected to one or more components of the HVAC system associated with a property. A module 337 can be configured to capture sensor data from, control operation of, or both, corresponding components of the HVAC system. In some implementations, the module 337 is configured to monitor energy consumption of an HVAC system component, for example, by directly measuring the energy consumption of the HVAC system components or by estimating the energy usage of the one or more HVAC system components by detecting usage of components of the HVAC system. The module 337 can communicate energy monitoring information, the state of the HVAC system components, or both, to the thermostat 334. The module 337 can control the one or more components of the HVAC system in response to receipt of commands received from the thermostat 334.

In some examples, the environment 300 includes one or more robotic devices 390. The robotic devices 390 can be any type of robots that are capable of moving, such as an aerial drone, a land-based robot, or a combination of both. The robotic devices 390 can take actions, such as capture sensor data or other actions that assist in security monitoring, property automation, or a combination of both. For example, the robotic devices 390 can include robots capable of moving throughout a property using automated navigation control technology, user input control provided by a user, or a combination of both. The robotic devices 390 can fly, roll, walk, or otherwise move about the property. The robotic devices 390 can include helicopter type devices (e.g., quad copters), rolling helicopter type devices (e.g., roller copter devices that can fly and roll along the ground, walls, or ceiling) and land vehicle type devices (e.g., automated cars that drive around a property). In some examples, the robotic devices 390 can be robotic devices 390 that are intended for other purposes and merely associated with the environment 300 for use in appropriate circumstances. For instance, a robotic vacuum cleaner device can be associated with the environment 300 as one of the robotic devices 390 and can be controlled to take action responsive to monitoring system events.

In some examples, the robotic devices 390 automatically navigate within a property. In these examples, the robotic devices 390 include sensors and control processors that guide movement of the robotic devices 390 within the property. For instance, the robotic devices 390 can navigate within the property using one or more cameras, one or more proximity sensors, one or more gyroscopes, one or more accelerometers, one or more magnetometers, a global positioning system (“GPS”) unit, an altimeter, one or more sonar or laser sensors, any other types of sensors that aid in navigation about a space, or a combination of these. The robotic devices 390 can include control processors that process output from the various sensors and control the robotic devices 390 to move along a path that reaches the desired destination, avoids obstacles, or a combination of both. In this regard, the control processors detect walls or other obstacles in the property and guide movement of the robotic devices 390 in a manner that avoids the walls and other obstacles.

In some implementations, the robotic devices 390 can store data that describes attributes of the property. For instance, the robotic devices 390 can store a floorplan, a three-dimensional model of the property, or a combination of both, that enable the robotic devices 390 to navigate the property. During initial configuration, the robotic devices 390 can receive the data describing attributes of the property, determine a frame of reference to the data (e.g., a property or reference location in the property), and navigate the property using the frame of reference and the data describing attributes of the property. In some examples, initial configuration of the robotic devices 390 can include learning one or more navigation patterns in which a user provides input to control the robotic devices 390 to perform a specific navigation action (e.g., fly to an upstairs bedroom and spin around while capturing video and then return to a property charging base). In this regard, the robotic devices 390 can learn and store the navigation patterns such that the robotic devices 390 can automatically repeat the specific navigation actions upon a later request.

In some examples, the robotic devices 390 can include data capture devices. In these examples, the robotic devices 390 can include, as data capture devices, one or more cameras, one or more motion sensors, one or more microphones, one or more biometric data collection tools, one or more temperature sensors, one or more humidity sensors, one or more air flow sensors, any other type of sensor that can be useful in capturing monitoring data related to the property and users in the property, or a combination of these. The one or more biometric data collection tools can be configured to collect biometric samples of a person in the property with or without contact of the person. For instance, the biometric data collection tools can include a fingerprint scanner, a hair sample collection tool, a skin cell collection tool, or any other tool that allows the robotic devices 390 to take and store a biometric sample that can be used to identify the person (e.g., a biometric sample with DNA that can be used for DNA testing).

In some implementations, the robotic devices 390 can include output devices. In these implementations, the robotic devices 390 can include one or more displays, one or more speakers, any other type of output devices that allow the robotic devices 390 to communicate information, e.g., to a nearby user or another type of person, or a combination of these.

The robotic devices 390 can include a communication module that enables the robotic devices 390 to communicate with the control unit 310, each other, other devices, or a combination of these. The communication module can be a wireless communication module that allows the robotic devices 390 to communicate wirelessly. For instance, the communication module can be a Wi-Fi module that enables the robotic devices 390 to communicate over a local wireless network at the property. Other types of short-range wireless communication protocols, such as 900 MHz wireless communication, Bluetooth, Bluetooth LE, Z-wave, Zigbee, Matter, or any other appropriate type of wireless communication, can be used to allow the robotic devices 390 to communicate with other devices, e.g., in or off the property. In some implementations, the robotic devices 390 can communicate with each other or with other devices of the environment 300 through the network 305.

The robotic devices 390 can include processor and storage capabilities. The robotic devices 390 can include any one or more suitable processing devices that enable the robotic devices 390 to execute instructions, operate applications, perform the actions described throughout this specification, or a combination of these. In some examples, the robotic devices 390 can include solid-state electronic storage that enables the robotic devices 390 to store applications, configuration data, collected sensor data, any other type of information available to the robotic devices 390, or a combination of two or more of these.

The robotic devices 390 can process captured data locally, provide captured data to one or more other devices for processing, e.g., the control unit 310 or the monitoring system 360, or a combination of both. For instance, the robotic device 390 can provide the images to the control unit 310 for processing. In some examples, the robotic device 390 can process the images to determine an identification of the items.

One or more of the robotic devices 390 can be associated with one or more charging stations. The charging stations can be located at a predefined home base or reference location in the property. The robotic devices 390 can be configured to navigate to one of the charging stations after completion of one or more tasks needed to be performed, e.g., for the environment 300. For instance, after completion of a monitoring operation or upon instruction by the control unit 310, a robotic device 390 can be configured to automatically fly to and connect with, e.g., land on, one of the charging stations. In this regard, a robotic device 390 can automatically recharge one or more batteries included in the robotic device 390 so that the robotic device 390 is less likely to need recharging when the environment 300 requires use of the robotic device 390, e.g., absent other concerns for the robotic device 390.

The charging stations can be contact-based charging stations, wireless charging stations, or a combination of both. For contact-based charging stations, the robotic devices 390 can have readily accessible points of contact to which a robotic device 390 can contact on the charging station. For instance, a helicopter type robotic device can have an electronic contact on a portion of its landing gear that rests on and couples with an electronic pad of a charging station when the helicopter type robotic device lands on the charging station. The electronic contact on the robotic device 390 can include a cover that opens to expose the electronic contact when the robotic device is charging and closes to cover and insulate the electronic contact when the robotic device 390 is in operation.

For wireless charging stations, the robotic devices 390 can charge through a wireless exchange of power. In these instances, a robotic device 390 needs only position itself closely enough to a wireless charging station for the wireless exchange of power to occur. In this regard, the positioning needed to land at a predefined home base or reference location in the property can be less precise than with a contact-based charging station. Based on the robotic devices 390 landing at a wireless charging station, the wireless charging station can output a wireless signal that the robotic device 390 receives and converts to a power signal that charges a battery maintained on the robotic device 390. As described in this specification, a robotic device 390 landing or coupling with a charging station can include a robotic device 390 positioning itself within a threshold distance of a wireless charging station such that the robotic device 390 is able to charge its battery.

In some implementations, one or more of the robotic devices 390 has an assigned charging station. In these implementations, the number of robotic devices 390 can equal the number of charging stations. In these implementations, the robotic devices 390 can always navigate to the specific charging station assigned to that robotic device 390. For instance, a first robotic device can always use a first charging station and a second robotic device can always use a second charging station.

In some examples, the robotic devices 390 can share charging stations. For instance, the robotic devices 390 can use one or more community charging stations that are capable of charging multiple robotic devices 390, e.g., substantially concurrently or separately or a combination of both at different times. The community charging station can be configured to charge multiple robotic devices 390 at substantially the same time, e.g., the community charging station can begin charging a first robotic device and then, while charging the first robotic device, begin charging a second robotic device five minutes later. The community charging station can be configured to charge multiple robotic devices 390 in serial such that the multiple robotic devices 390 take turns charging and, when fully charged, return to a predefined home base or reference location or another location in the property that is not associated with a charging station. The number of community charging stations can be less than the number of robotic devices 390.

In some instances, the charging stations might not be assigned to specific robotic devices 390 and can be capable of charging any of the robotic devices 390. In this regard, the robotic devices 390 can use any suitable, unoccupied charging station when not in use, e.g., when not performing an operation for the environment 300. For instance, when one of the robotic devices 390 has completed an operation or is in need of battery charge, the control unit 310 can reference a stored table of the occupancy status of each charging station and instructs the robotic device to navigate to the nearest charging station that has at least one unoccupied charger.

The environment 300 can include one or more integrated security devices 380. The one or more integrated security devices can include any type of device used to provide alerts based on received sensor data. For instance, the one or more control units 310 can provide one or more alerts to the one or more integrated security input/output devices 380. In some examples, the one or more control units 310 can receive sensor data from the sensors 320 and determine whether to provide an alert, or a message to cause presentation of an alert, to the one or more integrated security input/output devices 380.

The sensors 320, the module 322, the camera 330, the thermostat 334, the module 337, the integrated security devices 380, and the robotic devices 390, can communicate with the controller 312 over communication links 324, 326, 328, 332, 336, 338, 384, and 386. The communication links 324, 326, 328, 332, 336, 338, 384, and 386 can be a wired or wireless data pathway configured to transmit signals between any combination of the sensors 320, the module 322, the camera 330, the thermostat 334, the module 337, the integrated security devices 380, the robotic devices 390, or the controller 312. The sensors 320, the module 322, the camera 330, the thermostat 334, the module 337, the integrated security devices 380, and the robotic devices 390, can continuously transmit sensed values to the controller 312, periodically transmit sensed values to the controller 312, or transmit sensed values to the controller 312 in response to a change in a sensed value, a request, or both. In some implementations, the robotic devices 390 can communicate with the monitoring system 360 over network 305. The robotic devices 390 can connect and communicate with the monitoring system 360 using a Wi-Fi or a cellular connection or any other appropriate type of connection.

The communication links 324, 326, 328, 332, 336, 338, 384, and 386 can include any appropriate type of network, such as a local network. The sensors 320, the module 322, the camera 330, the thermostat 334, the robotic devices 390 and the integrated security devices 380, and the controller 312 can exchange data and commands over the network.

The monitoring system 360 can include one or more electronic devices, e.g., one or more computers. In some implementations, the monitoring system 360 can be implemented on one of the sensors 320, e.g., such as a camera. The monitoring system 360 is configured to provide monitoring services by exchanging electronic communications with the control unit 310, the one or more devices 340 and 350, the central alarm system 370, or a combination of these, over the network 305. For example, the monitoring system 360 can be configured to monitor events (e.g., alarm events) generated by the control unit 310. In these examples, the monitoring system 360 can exchange electronic communications with the network module 314 included in the control unit 310 to receive information regarding events (e.g., alerts) detected by the control unit 310. The monitoring system 360 can receive information regarding events (e.g., alerts) from the one or more devices 340 and 350.

In some implementations, the monitoring system 360 might be configured to provide one or more services other than monitoring services. In these implementations, the monitoring system 360 might perform one or more operations described in this specification without providing any monitoring services, e.g., the monitoring system 360 might not be a monitoring system as described in the example shown in FIG. 3.

In some examples, the monitoring system 360 can route alert data received from the network module 314 or the one or more devices 340 and 350 to the central alarm system 370. For example, the monitoring system 360 can transmit the alert data to the central alarm system 370 over the network 305.

The monitoring system 360 can store sensor and image data received from the environment 300 and perform analysis of sensor and image data received from the environment 300. Based on the analysis, the monitoring system 360 can communicate with and control aspects of the control unit 310 or the one or more devices 340 and 350.

The monitoring system 360 can provide various monitoring services to the environment 300. For example, the monitoring system 360 can analyze the sensor, image, and other data to determine an activity pattern of a person of the property monitored by the environment 300. In some implementations, the monitoring system 360 can analyze the data for alarm conditions or can determine and perform actions at the property by issuing commands to one or more components of the environment 300, possibly through the control unit 310.

The central alarm system 370 is an electronic device, or multiple electronic devices, configured to provide alarm monitoring service by exchanging communications with the control unit 310, the one or more mobile devices 340 and 350, the monitoring system 360, or a combination of these, over the network 305. For example, the central alarm system 370 can be configured to monitor alerting events generated by the control unit 310. In these examples, the central alarm system 370 can exchange communications with the network module 314 included in the control unit 310 to receive information regarding alerting events detected by the control unit 310. The central alarm system 370 can receive information regarding alerting events from the one or more mobile devices 340 and 350, the monitoring system 360, or both. In some implementations, the central alarm system 370 can be implemented, at least in part if not entirely, on the monitoring system 360. In these implementations, the monitoring system 360 can perform the operations described with reference to the central alarm system 370. One or both of the monitoring system 360 or the central alarm system 370 can be implemented in the cloud.

The central alarm system 370 is connected to multiple terminals 372 and 374. The terminals 372 and 374 can be used by operators to process alerting events. For example, the central alarm system 370, e.g., as part of a first responder system, can route alerting data to the terminals 372 and 374 to enable an operator to process the alerting data. The terminals 372 and 374 can include general-purpose computers (e.g., desktop personal computers, workstations, or laptop computers) that are configured to receive alerting data from a computer in the central alarm system 370 and render a display of information using the alerting data.

For instance, the controller 312 can control the network module 314 to transmit, to the central alarm system 370, alerting data indicating that a sensor 320 detected motion from a motion sensor via the sensors 320. The central alarm system 370 can receive the alerting data and route the alerting data to the terminal 372 for processing by an operator associated with the terminal 372. The terminal 372 can render a display to the operator that includes information associated with the alerting event (e.g., the lock sensor data, the motion sensor data, the contact sensor data, etc.) and the operator can handle the alerting event based on the displayed information. In some implementations, the terminals 372 and 374 can be mobile devices or devices designed for a specific function. Although FIG. 3 illustrates two terminals for brevity, actual implementations can include more (and, perhaps, many more) terminals.

The one or more devices 340 and 350 are devices that can present content, e.g., host and display user interfaces, audio data, or both. For instance, the mobile device 340 is a mobile device that hosts or runs one or more native applications (e.g., the smart property application 342). The mobile device 340 can be a cellular phone or a non-cellular locally networked device with a display. The mobile device 340 can include a cell phone, a smart phone, a tablet PC, a personal digital assistant (“PDA”), or any other portable device configured to communicate over a network and present information. The mobile device 340 can perform functions unrelated to the monitoring system, such as placing personal telephone calls, playing music, playing video, displaying pictures, browsing the Internet, and maintaining an electronic calendar.

The mobile device 340 can include a smart property application 342. The smart property application 342 refers to a software/firmware program running on the corresponding mobile device that enables the user interface and features described throughout. The mobile device 340 can load or install the smart property application 342 using data received over a network or data received from local media. The smart property application 342 enables the mobile device 340 to receive and process image and sensor data from the monitoring system 360.

The device 350 can be a general-purpose computer (e.g., a desktop personal computer, a workstation, or a laptop computer) that is configured to communicate with the monitoring system 360, the control unit 310, or both, over the network 305. The device 350 can be configured to display a smart property user interface 352 that is generated by the device 350 or generated by the monitoring system 360. For example, the device 350 can be configured to display a user interface (e.g., a web page) generated using data provided by the monitoring system 360 that enables a user to perceive images captured by the camera 330, reports related to the monitoring system, or both. Although FIG. 3 illustrates two devices for brevity, actual implementations can include more (and, perhaps, many more) or fewer devices.

In some implementations, the one or more devices 340 and 350 communicate with and receive data from the control unit 310 using the communication link 338. For instance, the one or more devices 340 and 350 can communicate with the control unit 310 using various wireless protocols, or wired protocols such as Ethernet and USB, to connect the one or more devices 340 and 350 to the control unit 310, e.g., local security and automation equipment. The one or more devices 340 and 350 can use a local network, a wide area network, or a combination of both, to communicate with other components in the environment 300. The one or more devices 340 and 350 can connect locally to the sensors and other devices in the environment 300.

Although the one or more devices 340 and 350 are shown as communicating with the control unit 310, the one or more devices 340 and 350 can communicate directly with the sensors and other devices controlled by the control unit 310. In some implementations, the one or more devices 340 and 350 replace the control unit 310 and perform one or more of the functions of the control unit 310 for local monitoring and long range, offsite, or both, communication.

In some implementations, the one or more devices 340 and 350 receive monitoring system data captured by the control unit 310 through the network 305. The one or more devices 340 and 350 can receive the data from the control unit 310 through the network 305, the monitoring system 360 can relay data received from the control unit 310 to the one or more devices 340 and 350 through the network 305, or a combination of both. In this regard, the monitoring system 360 can facilitate communication between the one or more devices 340 and 350 and various other components in the environment 300.

In some implementations, the one or more devices 340 and 350 can be configured to switch whether the one or more devices 340 and 350 communicate with the control unit 310 directly (e.g., through communication link 338) or through the monitoring system 360 (e.g., through network 305) based on a location of the one or more devices 340 and 350. For instance, when the one or more devices 340 and 350 are located close to, e.g., within a threshold distance of, the control unit 310 and in range to communicate directly with the control unit 310, the one or more devices 340 and 350 use direct communication. When the one or more devices 340 and 350 are located far from, e.g., outside the threshold distance of, the control unit 310 and not in range to communicate directly with the control unit 310, the one or more devices 340 and 350 use communication through the monitoring system 360.

Although the one or more devices 340 and 350 are shown as being connected to the network 305, in some implementations, the one or more devices 340 and 350 are not connected to the network 305. In these implementations, the one or more devices 340 and 350 communicate directly with one or more of the monitoring system components and no network (e.g., Internet) connection or reliance on remote servers is needed.

In some implementations, the one or more devices 340 and 350 are used in conjunction with only local sensors and/or local devices in a house. In these implementations, the environment 300 includes the one or more devices 340 and 350, the sensors 320, the module 322, the camera 330, and the robotic devices 390. The one or more devices 340 and 350 receive data directly from the sensors 320, the module 322, the camera 330, the robotic devices 390, or a combination of these, and send data directly to the sensors 320, the module 322, the camera 330, the robotic devices 390, or a combination of these. The one or more devices 340 and 350 can provide the appropriate interface, processing, or both, to provide visual surveillance and reporting using data received from the various other components.

In some implementations, the environment 300 includes network 305 and the sensors 320, the module 322, the camera 330, the thermostat 334, and the robotic devices 390 are configured to communicate sensor and image data to the one or more devices 340 and 350 over network 305. In some implementations, the sensors 320, the module 322, the camera 330, the thermostat 334, and the robotic devices 390 are programmed, e.g., intelligent enough, to change the communication pathway from a direct local pathway when the one or more devices 340 and 350 are in close physical proximity to the sensors 320, the module 322, the camera 330, the thermostat 334, the robotic devices 390, or a combination of these, to a pathway over network 305 when the one or more devices 340 and 350 are farther from the sensors 320, the module 322, the camera 330, the thermostat 334, the robotic devices 390, or a combination of these.

In some examples, the monitoring system 360 leverages GPS information from the one or more devices 340 and 350 to determine whether the one or more devices 340 and 350 are close enough to the sensors 320, the module 322, the camera 330, the thermostat 334, the robotic devices 390, or a combination of these, to use the direct local pathway or whether the one or more devices 340 and 350 are far enough from the sensors 320, the module 322, the camera 330, the thermostat 334, the robotic devices 390, or a combination of these, that the pathway over network 305 is required. In some examples, the monitoring system 360 leverages status communications (e.g., pinging) between the one or more devices 340 and 350 and the sensors 320, the module 322, the camera 330, the thermostat 334, the robotic devices 390, or a combination of these, to determine whether communication using the direct local pathway is possible. If communication using the direct local pathway is possible, the one or more devices 340 and 350 communicate with the sensors 320, the module 322, the camera 330, the thermostat 334, the robotic devices 390, or a combination of these, using the direct local pathway. If communication using the direct local pathway is not possible, the one or more devices 340 and 350 communicate with the sensors 320, the module 322, the camera 330, the thermostat 334, the robotic devices 390, or a combination of these, using the pathway over network 305.

In some implementations, the environment 300 provides people with access to images captured by the camera 330 to aid in decision-making. The environment 300 can transmit the images captured by the camera 330 over a network, e.g., a wireless WAN, to the devices 340 and 350. Because transmission over a network can be relatively expensive, the environment 300 can use several techniques to reduce costs while providing access to significant levels of useful visual information (e.g., compressing data, down-sampling data, sending data only over inexpensive LAN connections, or other techniques).

In some implementations, a state of the environment 300, one or more components in the environment 300, and other events sensed by a component in the environment 300 can be used to enable/disable video/image recording devices (e.g., the camera 330). In these implementations, the camera 330 can be set to capture images on a periodic basis when the alarm system is armed in an “away” state, set not to capture images when the alarm system is armed in a “stay” state or disarmed, or a combination of both. In some examples, the camera 330 can be triggered to begin capturing images when the control unit 310 detects an event, such as an alarm event, a door-opening event for a door that leads to an area within a field of view of the camera 330, or motion in the area within the field of view of the camera 330. In some implementations, the camera 330 can capture images continuously, but the captured images can be stored or transmitted over a network when needed.

In some implementations, when a device or system transmits data to another device or system, the transmission of the data, such as a message, can cause the other device or system to perform one or more actions. For instance, transmission of a message that includes an instruction to a camera can cause the camera to capture one or more images, transmit one or more images to the device or system, or a combination of both.

Although FIG. 3 depicts the monitoring system 360 as remote from the control unit 310, in some examples the control unit 310 can be a component of the monitoring system 360. For instance, both the monitoring system 360 and the control unit 310 can be physically located at a property that includes the sensors 320 or at a location outside the property.

In some examples, some of the sensors 320, the robotic devices 390, or a combination of both, might not be directly associated with the property. For instance, a sensor or a robotic device might be located at an adjacent property or on a vehicle that passes by the property. A system at the adjacent property or for the vehicle, e.g., that is in communication with the vehicle or the robotic device, can provide data from that sensor or robotic device to the control unit 310, the monitoring system 360, or a combination of both.

A number of implementations have been described. Nevertheless, it will be understood that various modifications can be made without departing from the spirit and scope of the disclosure. For example, various forms of the flows shown above can be used, with operations re-ordered, added, or removed.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, a data processing apparatus. Alternatively or in addition, the program instructions can be encoded on an artificially-generated propagated signal, e.g., a machine-generated electrical, optical, or electromagnetic signal, that is generated to encode information for transmission to a suitable receiver apparatus for execution by a data processing apparatus. One or more computer storage media can include a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can be or include special purpose logic circuitry, e.g., a field programmable gate array (“FPGA”) or an application-specific integrated circuit (“ASIC”). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can be performed by, and apparatus can also be implemented as, special purpose logic circuitry, e.g., a field programmable gate array (“FPGA”) or an application-specific integrated circuit (“ASIC”).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. A computer can be embedded in another device, e.g., a mobile telephone, a smart phone, a headset, a personal digital assistant (“PDA”), a mobile audio or video player, a game console, a Global Positioning System (“GPS”) receiver, or a portable storage device, e.g., a universal serial bus (“USB”) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a liquid crystal display (“LCD”), an organic light emitting diode (“OLED”) or other monitor, for displaying information to the user and a keyboard and a pointing device, e.g., a mouse or a trackball or a touchscreen, by which the user can provide input to the computer. Other kinds of devices can be used to provide for interaction with a user as well. For example, feedback provided to the user can be any form of sensory feedback, e.g., visual feedback, auditory feedback, or tactile feedback; and input from the user can be received in any form, including acoustic, speech, or tactile input. In some examples, a computer can interact with a user by sending documents to and receiving documents from a device that is used by the user; for example, by sending web pages to a web browser on a user’s device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an Hypertext Markup Language (“HTML”) page, to a user device, e.g., for purposes of displaying data to and receiving user input from a user device, which acts as a client. Data generated at the user device, e.g., a result of user interaction with the user device, can be received from the user device at the server.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some instances be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations have been described. Other implementations are within the scope of the following claims. For example, the operations recited in the claims, described in the specification, or depicted in the figures can be performed in a different order and still achieve desirable results. In some implementations, multitasking and parallel processing may be advantageous.

1. A computer-implemented method comprising:
maintaining, by a first system for a first property, radio sensor data that was captured by a radio receiver from radio waves reflected off of objects within a threshold distance of the first property;
receiving, by the first system and from a second system for a second property, a message that includes a representation of an object and indicates whether the object is likely an object of interest;
determining whether the radio sensor data encodes another representation of the object that satisfies a similarity criterion for the representation of the object included in the message; and
performing one or more actions using a result of the determination whether the radio sensor data encodes another representation of the object that satisfies the similarity criterion for the representation of the object included in the message.

2. The method of claim 1, comprising:
prior to receiving the message, determining that the other representation of the object likely represents an object of interest for the first property; and
in response to determining that the other representation of the object likely represents an object of interest for the first property, determining to wait for the message from the second system for the second property.

3. The method of claim 1, wherein:
receiving the message comprises receiving the message that includes the representation of an object and indicates that the object is likely an object of interest for the second property; and
performing the one or more actions comprises:
determining whether the object is an object of interest for the first property; and
in response to determining that the object is an object of interest for the first property and receiving the message that indicates that the object is likely an object of interest for the second property, triggering an alert.

4. The method of claim 1, wherein:
receiving the message comprises receiving the message that includes the representation of an object and indicates that the object is likely an object of interest for the second property; and
performing the one or more actions comprises:
determining whether the object is an object of interest for the first property; and
in response to determining that the object is not an object of interest for the first property and receiving the message that indicates that the object is likely an object of interest for the second property, transmitting, to the second system for the second property, a second message that indicates that the object is not an object of interest for the first property.

5. The method of claim 1, wherein:
receiving the message comprises receiving the message that includes the representation of an object and indicates that the object is likely an object of interest; and
performing the one or more actions comprises triggering an alert in response to determining that the radio sensor data encodes another representation of the object that satisfies the similarity criterion for the representation of the object that is likely an object of interest.

6. The method of claim 5, wherein performing the one or more actions comprises:
determining a predicted location for the object;
determining whether the predicted location for the object is at the second property; and
in response to determining that the predicted location for the object is not likely at the second property, triggering an alert.

7. The method of claim 5, wherein:
receiving the message comprises receiving the message that identifies first event data for a first event that includes the object; and
performing the one or more actions comprises, in response to determining that the radio sensor data encodes another representation of the object that satisfies the similarity criterion for the representation of the object that is likely an object of interest:
retrieving, from the radio sensor data and using the other representation of the object, second event data for a second event that includes the object;
generating an event series model for the object using the first event data for the first event that includes the object and the second event data for the second event that includes the object; and
performing an action using the event series model for the object.

8. The method of claim 7, comprising:
selecting, from a plurality of actions and using the event series model for the object, the action.

9. The method of claim 5, wherein receiving the message comprises receiving the message that indicates that the object is likely a person, an animal, or a vehicle.

10. The method of claim 1, wherein:
receiving the message comprises receiving the message that includes the representation of an object and indicates that the object is not likely an object of interest; and
performing the one or more actions comprises discarding the radio sensor data in response to determining that the radio sensor data encodes another representation of the object that satisfies the similarity criterion for the representation of the object that is not likely an object of interest.

11. The method of claim 10, wherein performing the one or more actions comprises:
determining a predicted location for the object;
determining whether the predicted location for the object is at the second property; and
in response to determining that the predicted location for the object is at the second property, discarding the radio sensor data.

12. The method of claim 10, wherein receiving the message comprises receiving the message that indicates that the object is not likely a person, an animal, or a vehicle.

13. The method of claim 10, wherein receiving the message comprises receiving the message that indicates that the object is a known object for the second property.

14. The method of claim 1, wherein the representation of the object comprises a radio frequency representation of the object.

15. The method of claim 1, wherein the first system is physically installed at the first property.

16. The method of claim 1, wherein the first system is a cloud computing system for the first property.

17. One or more computer storage media encoded with instructions that, when executed by one or more computers, cause the one or more computers to perform operations comprising:
maintaining, by a first system for a first property, radio sensor data that was captured by a radio receiver from radio waves reflected off of objects within a threshold distance of the first property;
receiving, by the first system and from a second system for a second property, a message that includes a representation of an object and indicates whether the object is likely an object of interest;
determining whether the radio sensor data encodes another representation of the object that satisfies a similarity criterion for the representation of the object included in the message; and
performing one or more actions using a result of the determination whether the radio sensor data encodes another representation of the object that satisfies the similarity criterion for the representation of the object included in the message.

18. The media of claim 17, the operations comprising:
prior to receiving the message, determining that the other representation of the object likely represents an object of interest for the first property; and
in response to determining that the other representation of the object likely represents an object of interest for the first property, determining to wait for the message from the second system for the second property.

19. The media of claim 17, wherein:
receiving the message comprises receiving the message that includes the representation of an object and indicates that the object is likely an object of interest for the second property; and
performing the one or more actions comprises:
determining whether the object is an object of interest for the first property; and
in response to determining that the object is an object of interest for the first property and receiving the message that indicates that the object is likely an object of interest for the second property, triggering an alert.

20. A system comprising one or more computers and one or more storage devices on which are stored instructions that are operable, when executed by the one or more computers, to cause the one or more computers to perform operations comprising:
maintaining, by a first system for a first property, radio sensor data that was captured by a radio receiver from radio waves reflected off of objects within a threshold distance of the first property;
receiving, by the first system and from a second system for a second property, a message that includes a representation of an object and indicates whether the object is likely an object of interest;
determining whether the radio sensor data encodes another representation of the object that satisfies a similarity criterion for the representation of the object included in the message; and
performing one or more actions using a result of the determination whether the radio sensor data encodes another representation of the object that satisfies the similarity criterion for the representation of the object included in the message.
